(19) United States
(12) Patent Application Publication
(10) Pub. No.: US 2026/0039059 A1
(43) Pub. Date: Feb. 5, 2026

(54) CONNECTOR DEVICE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Akihiro NISHITANI, Mie (JP); Takuma YOSHIOKA, Mie (JP)

(21) Appl. No.: 18/995,138

(22) PCT Filed: Jul. 10, 2023
(86) PCT No.: PCT/JP2023/025478

§ 371 Date: Jan. 16, 2025

(30) Foreign Application Priority Data
Jul. 29, 2022 (JP) 2022-121173

(51) Int. Cl. H01R 13/631

(52) U.S. Cl. CPC H01R 13/631

(57) ABSTRACT

A connector device includes a first housing fixed to a first base member, a second housing relatively displaceable with respect to a second base member, and a movable member mounted in the second base member and movable between a connection start position and a connection completion position in a direction orthogonal to a connection direction. The movable member includes first guide grooves and second guide grooves extending in a direction oblique to the connection direction. In the process of bringing the both base members closer, the both guide grooves connect the both housings while moving the movable member from the connection start position to the connection completion position. The both housings in a connection completed state are integrally relatively displaceable in a direction parallel to the connection direction with respect to the second base member in a state where the movable member reaches the connection completion position.

### TECHNICAL FIELD

The present disclosure relates to a connector device.

### BACKGROUND

Patent Document 1 discloses a standby connector having an outer housing mounted on a case of a motor and an inner housing. The standby connector is connected to a mating connector fixed to a case of an inverter. A spring member is mounted in the inner housing of the standby connector. A positional deviation between the mating connector and the inner housing is absorbed by resiliently deforming the spring member.

### PRIOR ART DOCUMENT

### Patent Document

Patent Document 1: JP 2011-009092 A

### SUMMARY OF THE INVENTION

### Problems to be Solved

In the above standby connector, the positional deviation can be absorbed in two-dimensional directions orthogonal to a connection direction of the mating connector and the inner housing. However, the positional deviation cannot be absorbed in a direction parallel to the connection direction of the mating connector and the inner housing.

A connector device of the present disclosure was completed on the basis of the above situation and aims to enable a positional deviation to be absorbed in a direction parallel to a connection direction.

### Means to Solve the Problem

The present disclosure is directed to a connector device with a first base member, a first housing fixed to the first base member, a second base member provided to be able to relatively approach the first base member, a second housing relatively displaceable with respect to the second base member, the second housing being connectable to the first housing as the first and second base members approach each other, and a movable member mounted in the second base member, the movable member being movable between a connection start position and a connection completion position in a direction orthogonal to a connection direction of the first and second housings, the movable member being formed with a guide portion extending in a direction oblique to the connection direction, the guide portion guiding to connect the first and second housings to each other while moving the movable member from the connection start position to the connection completion position in the process of bringing the first and second base members closer, and connection of the first and second housings being completed and the first and second housings in a connection completed state being integrally relatively displaceable in a direction parallel to the connection direction with respect to the second base member in a state where the movable member reaches the connection completion position.

### Effect of the Invention

According to the present disclosure, a positional deviation can be absorbed in a direction parallel to a connection direction.

### BRIEF DESCRIPTION OF THE DRAWINGS

FIG. 1 is a perspective view showing a state before the connection of a first connector and a second connector.

FIG. 2 is a perspective view of a second base member.

FIG. 3 is a perspective view of a movable member.

FIG. 4 is a perspective view of a second housing when viewed obliquely from an upper front side.

FIG. 5 is a perspective view of the second housing when viewed obliquely from an upper rear side.

FIG. 6 is a side view showing the state before the connection of the first and second connectors.

FIG. 7 is a partial enlarged side view of FIG. 6.

FIG. 8 is a side view showing a state where the connection of a first housing and the second housing is started.

FIG. 9 is a side view showing a state where the connection of the first and the second housing is completed.

FIG. 10 is a partial enlarged side view of FIG. 9.

FIG. 11 is a side view showing a state where the first and second housings in a properly connected state are moved to absorb a positional deviation between a first base member and the second base member in a connection direction.

FIG. 12 is a partial enlarged side view of FIG. 11.

FIG. 13 is a section along X-X of FIG. 6.

FIG. 14 is a section along Y-Y of FIG. 9.

FIG. 15 is a front view of the second connector in the state of FIGS. 1 and 6.

FIG. 16 is a partial enlarged perspective view showing the state of FIG. 15 when viewed obliquely from the upper rear side.

FIG. 17 is a front view of the second connector in the state of FIG. 8.

FIG. 18 is a partial enlarged side view in section showing a locked state of a coupling projection of the first housing and a coupling groove of the second housing.

### DETAILED DESCRIPTION TO EXECUTE THE INVENTION

### Description of Embodiments of Present Disclosure

First, embodiments of the present disclosure are listed and described.

(1) The connector device of the present disclosure is provided with a first base member, a first housing fixed to the first base member, a second base member provided to be able to relatively approach the first base member, a second housing relatively displaceable with respect to the second base member, the second housing being connectable to the first housing as the first and second base members approach each other, and a movable member mounted in the second base member, the movable member being movable between a connection start position and a connection completion position in a direction orthogonal to a connection direction of the first and second housings. The movable member is formed with a guide portion extending in a direction oblique to the connection direction. The guide portion guides to connect the first and second housings to each other while moving the movable member from the connection start position to the connection completion position in the process of bringing the first and second base members closer. Connection of the first and second housings is completed and the first and second housings in a connection completed state are integrally relatively displaceable in a direction parallel to the connection direction with respect to the second base member in a state where the movable member reaches the connection completion position.

According to the present disclosure, the first and second housings are connected by the guide portion in the process of bringing the first and second base members closer and, during this time, the movable member moves from the connection start position to the connection completion position. In the state where the movable member reaches the connection completion position, the first and second housings can be relatively displaced in the direction parallel to the connection direction with respect to the second base member while being kept in the connection completed state. As the both housings are relatively displaced with respect to the second base member, the first and second base members are relatively displaced in the direction parallel to the connection direction of the first and second housings. In this way, a positional deviation between the first and second base members can be absorbed in the direction parallel to the connection direction of the both housings.

(2) Preferably, the guide portion includes a first guide groove, a first cam pin of the first housing being brought into sliding contact with the first guide groove in the process of connecting the first and second housings, the movable member is formed with a first release groove communicating with a final end part of the first guide groove, and the first cam pin enters the first release groove and becomes relatively movable in the direction parallel to the connection direction with respect to the movable member when the movable member reaches the connection completion position. According to this configuration, if the connection of the first and second housings is completed in the process of bringing the first and second base members closer, the both housings are successively relatively displaced with respect to the second base member. In this way, the connection of the first and second housings and the positional deviation absorption of the first and second base members can be performed in one action.

(3) Preferably in (2), the guide portion includes a second guide groove, a second cam pin of the second housing being brought into sliding contact with the second guide groove in the process of connecting the first and second housings, the movable member is formed with a second release groove communicating with a final end part of the second guide groove, and the second cam pin enters the second release groove and becomes relatively movable in the direction parallel to the connection direction with respect to the movable member when the movable member reaches the connection completion position. According to this configuration, since the guide portion extends in the direction oblique to the connection direction, the second guide groove included in the guide portion also extends in the direction oblique to the connection direction. As compared to the case where the second housing is relatively displaced in the direction orthogonal to the connection direction with respect to the second base member in the connection process without providing the second guide groove, a stroke in the connection direction in the connection process of the both housings becomes longer. Since a sudden increase of connection resistance between the both housings can be avoided in this way, workability is good.

(4) Preferably in (2) or (3), a pair of the first guide grooves are provided apart from each other in the direction orthogonal to the connection direction, and the first cam pins are arranged at the same interval as the pair of first guide grooves in the direction orthogonal to the connection direction. According to this configuration, the inclination of the first housing with respect to the movable member can be prevented by bringing the pair of first cam pins into sliding contact with the pair of first guide grooves.

(5) Preferably in (3), a pair of the second guide grooves are provided apart from each other in the direction orthogonal to the connection direction, and the second cam pins are arranged at the same interval as the pair of second guide grooves in the direction orthogonal to the connection direction.

According to this configuration, the inclination of the second housing with respect to the movable member can be prevented by bringing the pair of second cam pins into sliding contact with the pair of second guide grooves.

(6) Preferably in (3), the final end part of the first release groove communicates with a start end part of the second guide groove. According to this configuration, the second cam pin can be guided into the second guide groove by the first guide groove and the first release groove when the second cam pin is mounted into the second guide groove.

(7) Preferably in (3), the movable member is provided with a holding portion for holding the second cam pin in a start end part of the second guide groove. According to this configuration, since the second housing is positioned with respect to the movable member by holding the second cam pin in the start end part of the second guide groove, a connecting operation of the first and second housings can be smoothly started.

(8) Preferably in (7), the holding portion includes a resilient holding piece formed on one of the second housing and the movable member and exhibiting a holding function by being locked to the other of the second housing and the movable member, and the first housing is provided with a releasing portion for releasing locking by the resilient holding piece when the connection of the first and second housings is started. According to this configuration, when the connection of the first and second housings is started, the holding by the resilient holding piece is released by the releasing portion and the second housing becomes relatively movable with respect to the movable member. Since an operation for only releasing the holding of the resilient holding piece is not necessary, workability is good.

### Details of Embodiment of Present Disclosure

### Embodiment

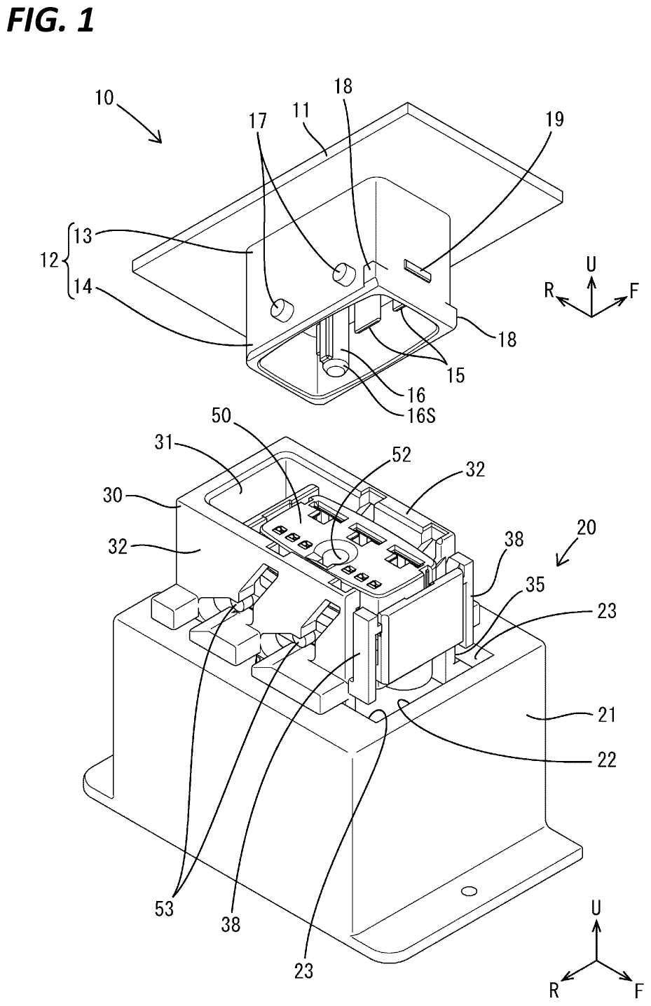

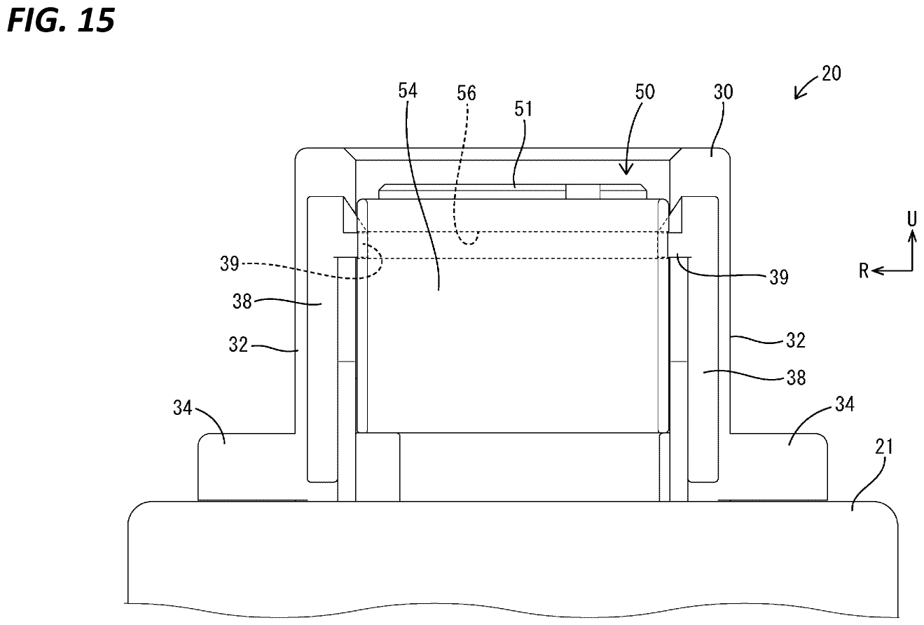

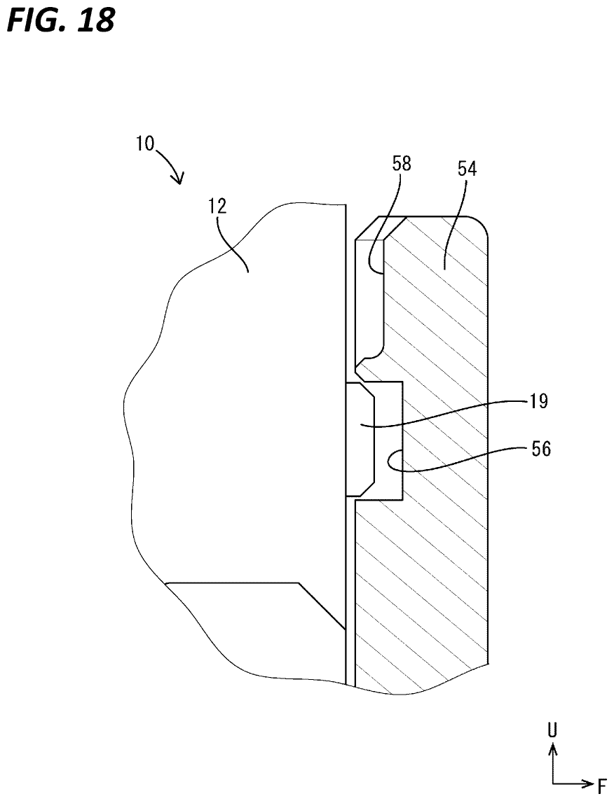

A connector device of one specific embodiment of the present disclosure is described with reference to FIGS. 1 to 18. The present invention is not limited to these illustrations, but is represented by claims and includes all changes in the scope of claims and in the meaning and scope of equivalents. In this embodiment, a direction F in FIGS. 1 to 14, 16 and 18 is defined as a forward direction concerning a front-rear direction. A direction R in FIGS. 1 to 5 and 13 to 17 is defined as a rightward direction concerning a lateral direction. A direction U in FIGS. 1 to 12 and 15 to 18 is defined as an upward direction concerning a vertical direction.

### Overall Configuration of Connector Device

The connector device of this embodiment includes, as shown in FIG. 1, a first connector 10 and a second connector 20 arranged below the first connector 10. The first and second connectors 10, 20 are connectable to each other. The first connector 10 is parallelly movable in the vertical direction. The second connector 10 is provided in a standby state (fixed state so as not to move). A connection direction of the first and second connectors 10, 20 is the vertical direction. The first connector 10 is provided with a first base member 11 and a first housing 12 fixed to the lower surface of the first base member 11. A surface of the first connector 10 facing the second connector 20 is facing downward.

As shown in FIG. 1, the second connector 20 is configured by assembling a second base member 21, a movable member 30 and a second housing 50. The second base member 21 is provided in a fixed state. The movable member 30 is mounted relatively displaceably only in two-dimensional directions (front-rear direction and lateral direction) with respect to the second base member 21. The second housing 50 is mounted relatively displaceably only in two-dimensional directions (front-rear direction and vertical direction) with respect to the movable member 30. The second housing 50 is provided relatively displaceably in three-dimensional directions (vertical direction, front-rear direction and lateral direction) with respect to the second base member 21. A surface of the second connector 20 facing the first connector 10 is facing upward.

The first and second base members 11, 21 are assembled by being brought closer in the vertical direction, and fixed in an assembled state by an unillustrated fitting structure, fastening structure or the like. In the process of bringing the first and second base members 11, 21 closer, the first and second housings 12, 50 are connected. A connection direction of the first and second housings 12, 50 (hereinafter, merely referred to as a “connection direction”) is a direction parallel to an assembly direction of the first and second base members 11, 21. A positional relationship of the first and second base members 11, 21 fixed in the assembled state varies within an assembly tolerance range. This variation occurs in the three-dimensional directions. Since the second housing 50 is provided relatively displaceably in the three-dimensional directions with respect to the second base member 21 as described above, the first and second housings 12, 50 can be connected while absorbing a positional deviation between the first and second base members 11, 21. The detailed structures of the first and second connectors 10, 20 are described below.

### Detail Structure of First Connector 10

The first base member 11 shown in FIG. 1 has a flat plate shape having a plate thickness direction oriented in the vertical direction. The first base member 11 includes fitting portions (not shown) and assembling portions (not shown) to be assembled with the second base member 21. The first housing 12 includes a terminal holding portion 13 having a rectangular parallelepiped shape and a receptacle 14 in the form of a rectangular tube projecting downward from the outer peripheral edge of the lower surface of the terminal holding portion 13. A plurality of first terminal fittings 15, which are male terminal fittings, are held in the terminal holding portion 13. Tabs (lower end parts) of the first terminal fittings 15 project downward from the terminal holding portion 13 and are surrounded by the receptacle 14.

The first housing 12 is formed with a guide pin 16. The guide pin 16 projects from the lower surface of the terminal holding portion 13 to a position below the lower end of the receptacle 14. A first tapered surface 16S having a tapered shape is formed on a lower end part (tip part) of the guide pin 16. A pair of first cam pins 17 in the form of cylindrical projections are formed on each of both left and right outer side surfaces of the receptacle 14. On each outer side surface, the pair of first cam pins 17 are arranged apart from each other in the front-rear direction and at same height in the vertical direction. A pair of left and right releasing portions 18 are formed on a lower end part of the outer peripheral surface of the receptacle 14. The pair of releasing portions 18 are arranged at corner parts where the both left and right outer side surfaces and the front surface are connected. A coupling projection 19 is formed on each of both front and rear surfaces of the outer peripheral surface of the receptacle 14. The coupling projections 19 are arranged at positions above the releasing portions 18.

### Detailed Structure of Second Connector 20

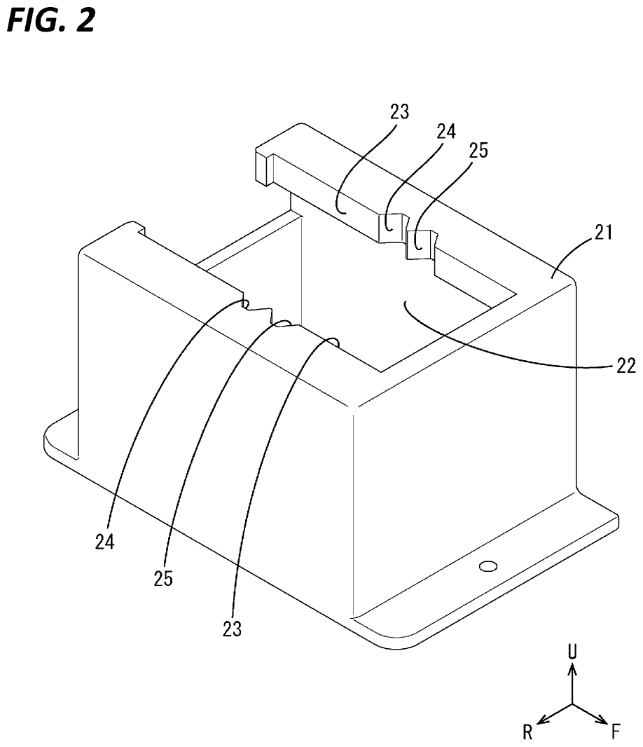

The second base member 21 is a box-shaped member. As shown in FIG. 2, a working space 22 open in the upper and rear surfaces of the second base member 21 is formed inside the second base member 21. Out of a horizontal upper wall portion of the second base member 21, parts constituting an opening edge part of the working space 22 function as a pair of left and right guide rails 23 extending in the front-rear direction. Each of the both guide rails 23 is formed with a connection start position recess 24 and a connection completion position recess 25 arranged forward of the connection start position recess 24.

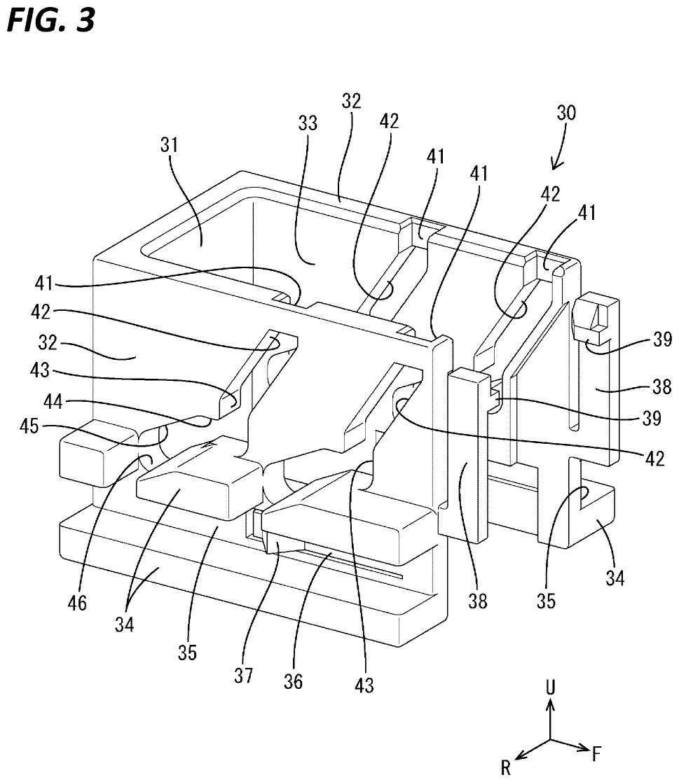

As shown in FIG. 3, the movable member 30 is a single component having a rear wall portion 31 and a pair of left and right side wall portions 32. A connection space 33 open in the both upper and lower surfaces and the front surface of the movable member 30 is formed inside the movable member 30. The first and second housings 12, 50 are connected in the connection space 33. A pair of upper and lower ribs 34 are formed apart from each other in the vertical direction on a lower end part of the outer side surface of each of the both left and right side wall portions 32. A groove portion 35 extending in the front-rear direction is formed between the pair of ribs 34.

As shown in FIGS. 3, 13 and 14, a resilient locking piece 36 cantilevered rearward is formed in a region facing the groove portion 35, out of each of the both left and right side wall portions 32. The resilient locking piece 36 can be resiliently displaced in the lateral direction. A locking projection 37 is formed on a rear end part of the outer side surface of the resilient locking piece 36. As shown in FIG. 3, a pair of left and right resilient holding pieces 38 are formed on a front end part of the movable member 30. The resilient holding pieces 38 have a cantilever shape extending upward from lower end parts of the front end edges of the both side wall portions 32. The resilient holding piece 38 can be resiliently deformed to tilt in the lateral direction. A projection 39 projecting laterally inward is formed on an upper end part of each of the both left and right resilient holding pieces 38.

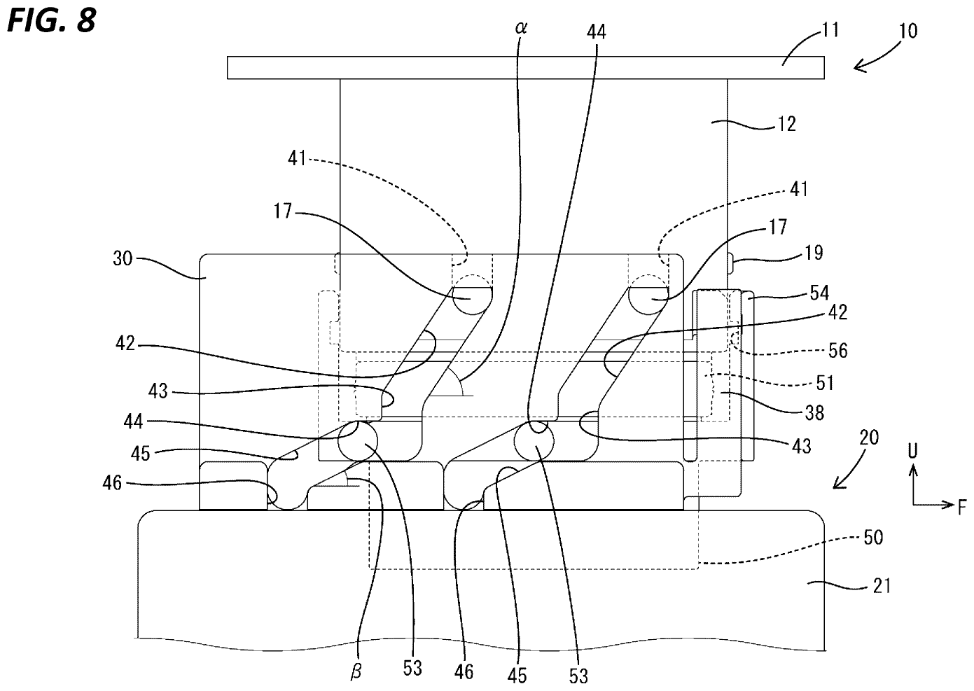

As shown in FIGS. 3 and 8, each of the both left and right side wall portions 32 of the movable member 30 is formed with a pair of front and rear entrance grooves 41, a pair of front and rear first guide grooves 42, a pair of front and rear first release grooves 43, a pair of front and rear communication grooves 44, a pair of front and rear second guide grooves 45 and a pair of front and rear second release grooves 46. The first and second guide grooves 42, 45 function to connect the first and second housings 12, 50 in the process of displacing the both housings 12, 50 downward.

The pair of entrance grooves 41 are arranged apart from each other in the front-rear direction and in parallel to each other. The entrance groove 41 extends in the vertical direction parallel to the connection direction of the both housings 12, 50 and is open in the upper end surface of the side wall portion 32. The pair of first guide grooves 42 are arranged apart from each other in the front-rear direction and in parallel to each other. The first guide groove 42 linearly extends in an obliquely downward direction from a final end part (lower end part) of the entrance groove 42. A start end part (upper end part) of the first guide groove 42 is the same part as the final end part of the entrance groove 41. The pair of first guide grooves 42 are oblique to both the vertical direction (direction parallel to the connection direction of the both housings 12, 50) and the front-rear direction (direction orthogonal to the connection direction of the both housings 12, 50).

The pair of first release grooves 43 are arranged apart from each other in the front-rear direction and in parallel to each other. The first release groove 43 extends downward from a final end part (lower rear end part) of the first guide groove 42. A start end part (upper end part) of the first release groove 43 is the same part as the final end part of the first guide groove 42. A dimension in the vertical direction of the first release groove 43 is smaller than that of the first guide groove 42. An interval in the front-rear direction between the pair of entrance grooves 41, that between the pair of first guide grooves 42 and that between the pair of first release grooves 43 are all equal to an interval between the pair of first cam pins 17.

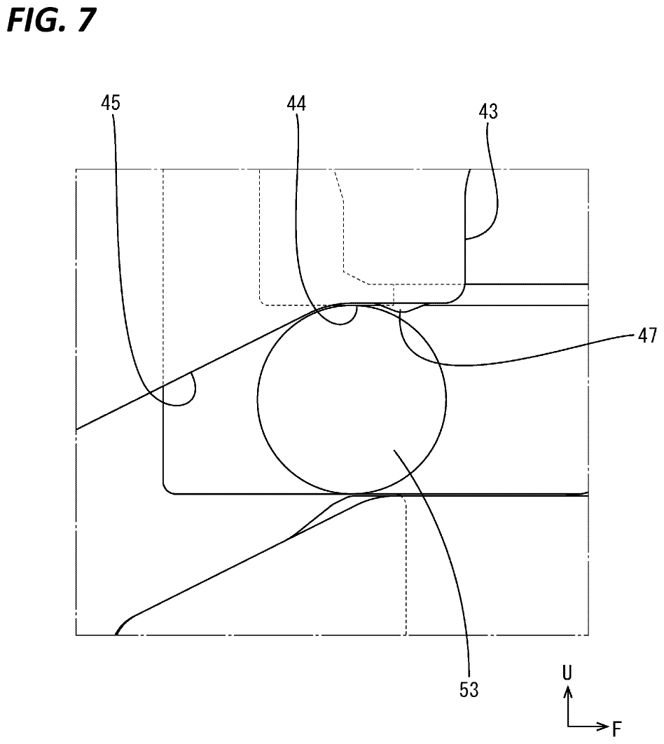

The pair of communication grooves 44 are arranged apart from each other in the front-rear direction and in parallel to each other. The communication groove 44 linearly extends rearward (in a direction orthogonal to the connection direction of the both housings 12, 50) from a final end part (lower end part) of the first release groove 43. A start end part (front end part) of the communication groove 44 is the same part as the final end part of the first release groove 43. As shown in FIG. 7, the rear communication groove 44 is formed with a holding projection 47. The holding projection 47 projects downward from an upper surface, out of both upper and lower surfaces constituting the communication groove 44.

The pair of second guide grooves 45 are arranged apart from each other in the front-rear direction and in parallel to each other. The second guide groove 45 linearly extends obliquely to a lower rear side from a final end part (rear end part) of the communication groove 44. A start end part (upper front end part) of the second guide groove 45 is the same part as the final end part of the communication groove 44. The pair of second guide grooves 45 are oblique to both the vertical direction and the front-rear direction. A dimension in the front-rear direction of the second guide groove 45 is equal to that of the first guide groove 42. A dimension in the vertical direction of the second guide groove 45 is smaller than that of the first guide groove 42. As shown in FIG. 8, in a side view of the movable member 30, an inclination angle β of the second guide groove 45 to a horizontal direction (front-rear direction) is smaller than an inclination angle α of the first guide groove 42.

The pair of second release grooves 46 are arranged apart from each other in the front-rear direction and in parallel to each other. The second release groove 46 extends downward from a final end part (lower rear end part) of the second guide groove 45. A start end part (upper end part) of the second release groove 46 is the same part as the final end part of the second guide groove 45. A dimension in the vertical direction (direction parallel to the connection direction of the both housings 12, 50) of the second release groove 46 is smaller than that of the second guide groove 45 and equal to that of the first release groove 43. The dimensions in the vertical direction of the first release groove 43 and the second release groove 46 are set to be larger than an expected positional deviation amount in the vertical direction between the first and second base members 11, 21.

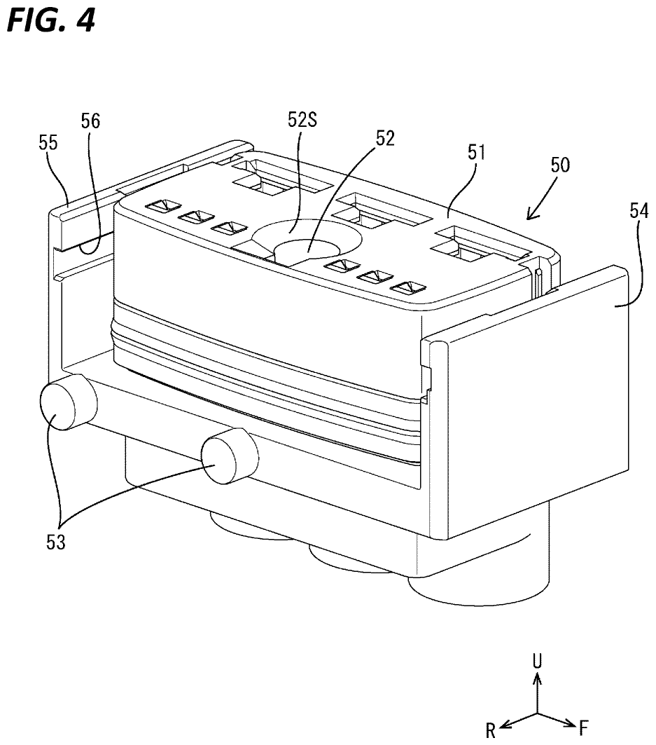

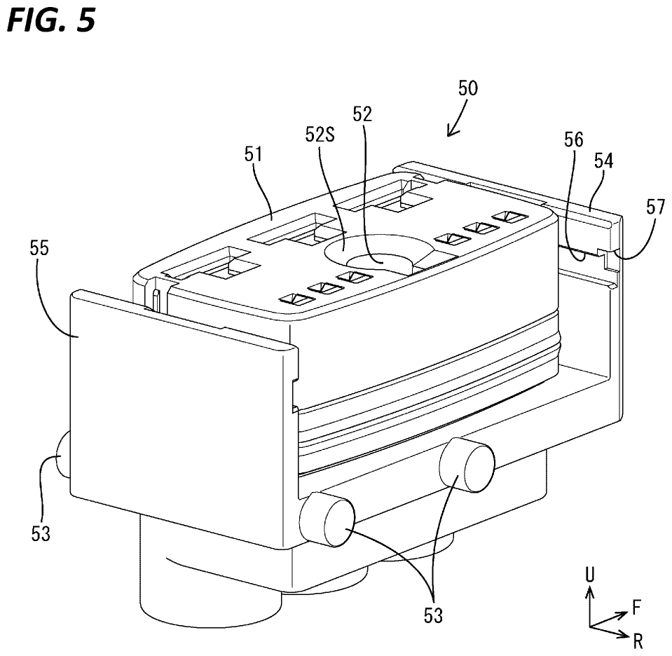

The second housing 50 is configured by assembling a plurality of components and includes, as shown in FIGS. 4 and 5, a housing body 51, a front plate portion 54 and a rear plate portion 55. A plurality of second terminal fittings (not shown), which are female terminal fittings, are accommodated inside the housing body 51. Wires (not shown) connected to the second terminal fittings are drawn out downward from the housing body 51. A facing surface of the housing body 51 facing the first housing 12 is formed with a guide hole 52 extending in the vertical direction. A second tapered surface 52S expanding toward an upper side is formed on an opening edge part of the guide hole 52.

A pair of second cam pins 53 in the form of cylindrical projections are formed on each of both left and right outer side surfaces of the housing body 51. On each outer side surface, the pair of second cam pins 53 are arranged apart from each other in the front-rear direction and at the same height in the vertical direction. An interval between the pair of second cam pins 53 is equal to the interval between the pair of first cam pins 17, an interval in the front-rear direction between the pair of second guide grooves 45 and an interval in the front-rear direction between the pair of second guide grooves 46.

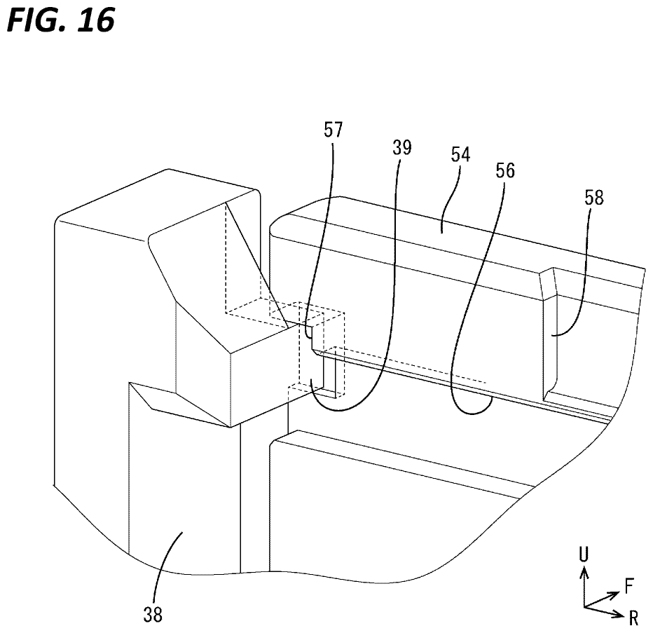

The front plate portion 54 has a flat plate shape having a plate thickness direction oriented in the front-rear direction. The front plate portion 54 is formed to rise upward from a lower end part of the front surface of the housing body 51. The rear plate portion 55 has a flat plate shape having a plate thickness direction oriented in the front-rear direction. The rear plate portion 55 is formed to rise upward from a lower end part of the rear surface of the housing body 51. A coupling groove 56 extending in the lateral direction over the entire width of the front plate portion 54 is formed in the rear surface of the front plate portion 54. A coupling groove 56 extending in the lateral direction over the entire width of the rear plate portion 55 is also formed in the rear surface of the rear plate portion 55, similar to the front plate portion 54. As shown in FIG. 16, a pair of holding recesses 57 are formed in both left and right end parts of the coupling groove 56 formed in the front plate portion 54. An upper end part of the rear surface of the front plate portion 54 is cut from the upper end edge of the front plate portion 54 toward the coupling groove 56 to form a guide rail 58. An upper end part of the rear surface of the rear plate portion 55 is also cut from the upper end edge of the rear plate portion 55 toward the coupling groove 56 to form a guide rail 58, similarly to the front plate portion 54.

Next, an assembly process and a connection process of the connector device are described. Before connection, the first connector 10 is set in a standby state above the second connector 20. In the second connector 20, the second terminal fittings (not shown) are mounted into the second housing 50, the second housing 50 is assembled with the movable member 30, and the movable member 30 is assembled with the second base member 21. In assembling the second housing 50 with the movable member 30, the second housing 50 is arranged above the movable member 30 and the wires (not shown) drawn out downward from the second housing 50 are passed through the connection space 33 of the movable member 30.

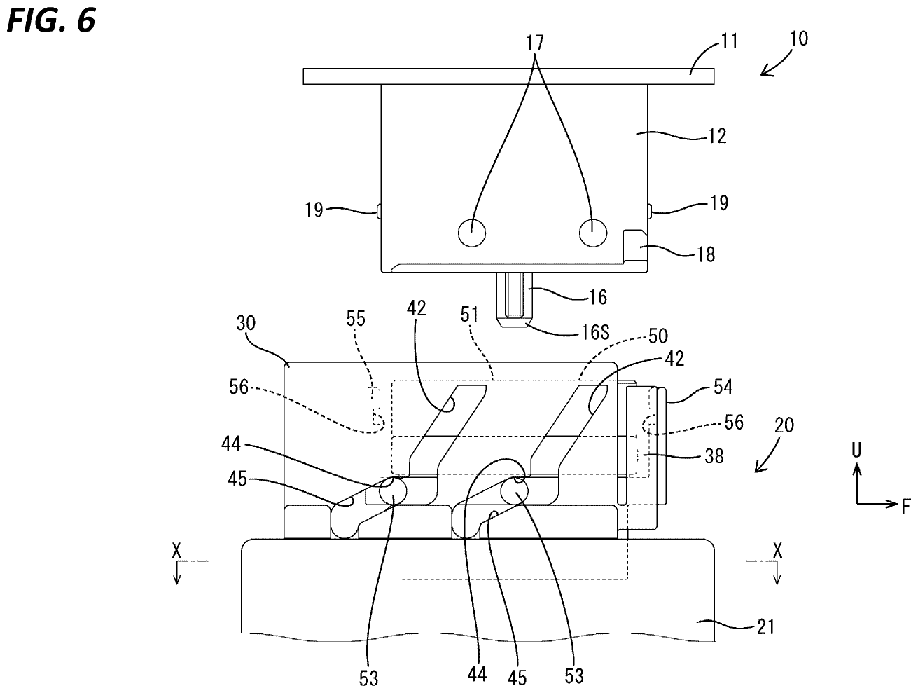

In this state, the second housing 50 is lowered and four second cam pins 53 are individually inserted into four entrance grooves 41. Thereafter, the four second cam pins 53 are successively brought into sliding contact with the first guide grooves 42, the first release grooves 43 and the communication grooves 44 and moved to the start end parts of the second guide grooves 45, as shown in FIGS. 6 and 7, while the second housing 50 is inserted into the connection space 33. During this time, the second housing 50 is relatively displaced obliquely to a lower rear side with respect to the movable member 30.

In a state where the four second cam pins 53 reach the start end parts of the second guide grooves 45, the holding recesses 57 of the coupling groove 56 of the front plate portion 54 are fit to the projections 39 of the resilient holding pieces 38 as shown in FIG. 16. By this fitting, the second housing 50 is restricted from being relatively displaced rearward and downward with respect to the movable member 30. That is, the second cam pins 53 cannot move toward the final ends of the second guide grooves 45. In the state where the second cam pins 53 reach the start end parts of the second guide grooves 45, the rear second cam pins 53 are locked to the holding projections 47 as shown in FIG. 7. By this locking, the second cam pins 53 cannot move toward the first release grooves 43 (side opposite to the final end parts of the second guide grooves 45). In the above way, the second housing 50 is held in a state restricted from being relatively displaced in the front-rear direction and the vertical direction with respect to the movable member 30 with the second cam pins 53 located at the start end parts of the second guide grooves 45. In the above way, the assembly of the second housing 50 with the movable member 30 is completed.

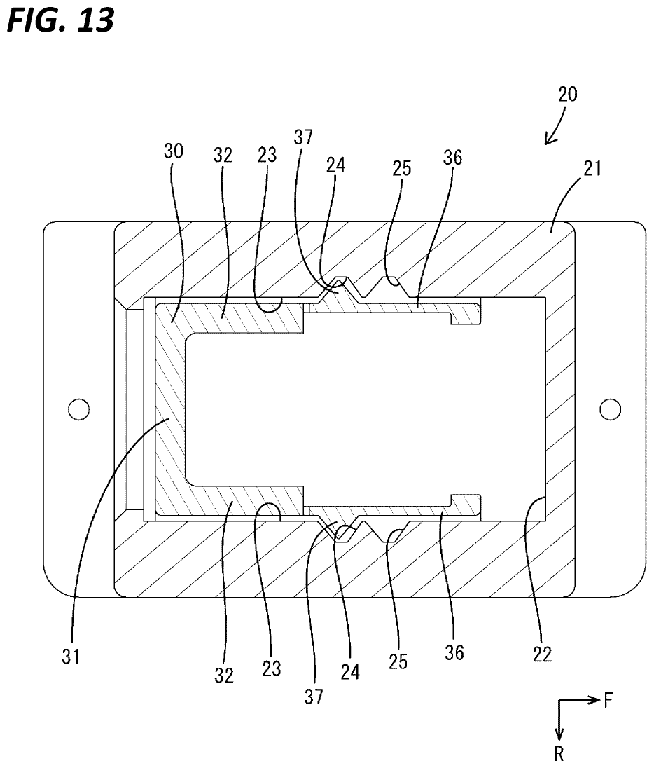

After the second housing 50 is assembled with the movable member 30, the movable member 30 is assembled with the second base member 21 from behind. At this time, a lower end part of the movable member 30 is inserted into the working space 22 while the groove portions 35 are fit to and brought into sliding contact with the guide rails 23. As shown in FIG. 13, when the locking projections 37 of the resilient locking pieces 36 are fit into the connection start position recesses 24, the assembly of the movable member 30 with the second base member 21 is completed. In this state, the movable member 30 is held at a connection start position by the locking of the resilient locking pieces 36 and the connection start position recesses 24.

With the movable member 30 held at the connection start position, clearances necessary to absorb a positional deviation in the lateral direction between the first and second base members 11, 21 are secured between the outer side surfaces of the side wall portions 32 of the movable member 30 and the inner surfaces of the guide rails 23 as shown in FIG. 13. Similarly, with the movable member 30 held at the connection start position, clearances necessary to absorb a positional deviation in two-dimensional directions (front-rear direction and lateral direction) between the first and second base members 11, 21 are secured between the locking projections 37 and the connection start position recesses 24. However, clearances for absorbing a positional deviation in the vertical direction between the first and second base members 11, 21 are not secured between the inner surfaces (pairs of upper and lower ribs 34) of the groove portions 35 of the second base member 21 and both upper and lower surfaces of the guide rails 23.

In the above way, preparation for the start of the connection of the second connector 20 to the first connector 10 is completed at the same time as the assembly of the second connector 20 is completed. Note that the movable member 30 may be assembled with the second base member 21 before the assembly of the second housing 50 with the movable member 30.

After the preparation for the connection of the both connectors 10, 20 is completed, the first base member 11 is lowered and brought closer to the second base member 21 and the lower end part of the guide pin 16 is fit into the guide hole 52. At this time, if the first and second housings 12, 50 are positionally deviated in the horizontal direction (front-rear direction or lateral direction), the first and second tapered surfaces 16S, 52S slide in contact with each other, whereby the second housing 50 and the movable member 30 are displaced in the front-rear direction or the lateral direction and the positional deviation between the both housings 12, 50 is absorbed. Since the clearances are secured in the horizontal direction between the movable member 30 and the second base member 21, the second base member 21 does not move. If the first connector 10 is lowered while the guide pin 16 is fit into the guide hole 52, a lower end part of the first housing 12 is externally fit to an upper end part of the second housing 50 and, as shown in FIG. 8, the four first cam pins 17 enter the entrance grooves 41 and reach the start end parts of the first guide grooves 42.

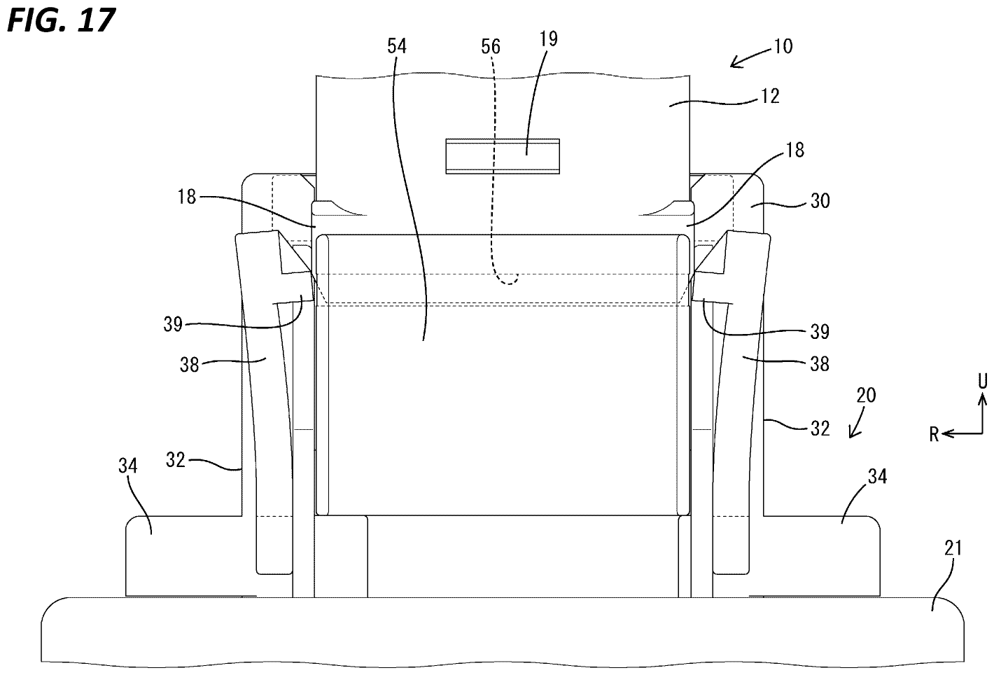

In a state where the first cam pins 17 reach the start end parts of the first guide grooves 42, the releasing portions 18 of the first housing 12 are in contact with upper end parts of the resilient holding pieces 38 and resiliently deform the resilient holding pieces 38 to tilt the resilient holding pieces 38 laterally outward as shown in FIG. 17. If the resilient holding pieces 38 are resiliently deformed, the projections 39 are disengaged from the holding recesses 57 of the second housing 50, wherefore the second housing 50 can relatively move obliquely to the lower rear side with respect to the movable member 30.

If the first connector 10 is further lowered from this state, the first cam pins 17 move downward in the first guide grooves 42 and press the inclined surfaces of the first guide grooves 42. Thus, the movable member 30 is pushed and moved forward while being guided by the guide rails 23. If the movable member 30 moves forward, the inclined surfaces of the second guide grooves 45 press the second cam pins 53 obliquely to a lower front side. Since the second housing 50 is restricted from moving in the front-rear direction by being connected to the first housing 12, the second housing 50 is pushed and moved downward as the movable member 30 moves forward. That is, the first and second housings 12, 50 move downward without being relatively displaced in the front-rear direction.

Here, the inclination angle α of the first guide grooves 42 to the horizontal direction (moving direction of the movable member 30) is set to be larger than the inclination angle β of the second guide grooves 45. Accordingly, a downward (approaching direction of the second housing 50 and the movable member 30) moving distance of the first housing 12 when the movable member 30 moves forward by a certain distance is larger than a downward (direction approaching the movable member 30) moving distance of the second housing 50. In this way, in the process of bringing the first connector 10 closer to the second base member 21, the first housing 12 approaches the second housing 50 and a connecting operation of the both housings 12, 50 progresses while the first and second housings 12, 50 are moving downward.

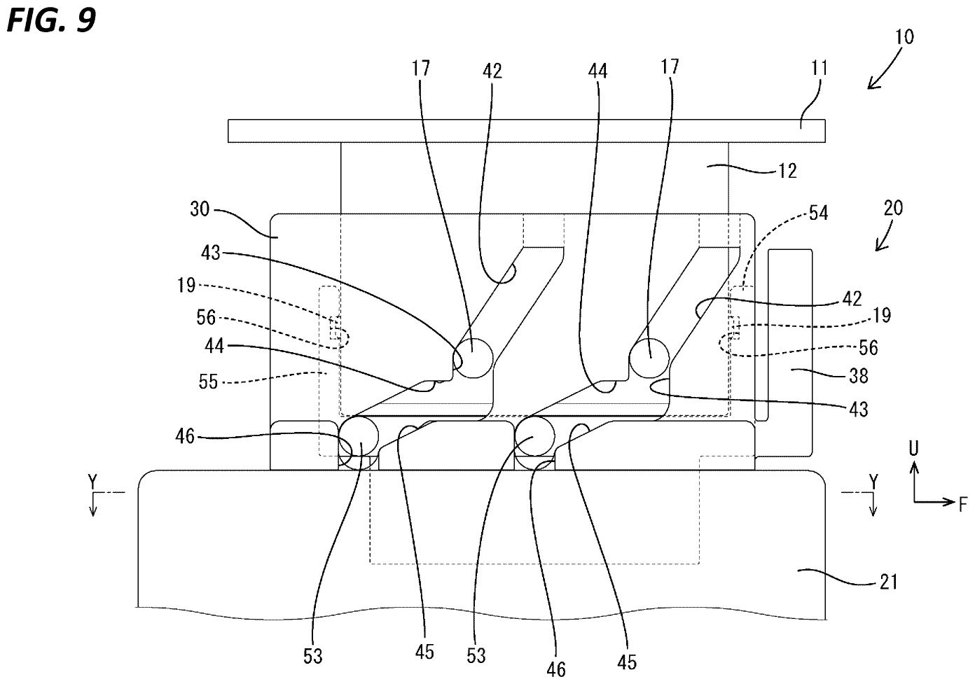

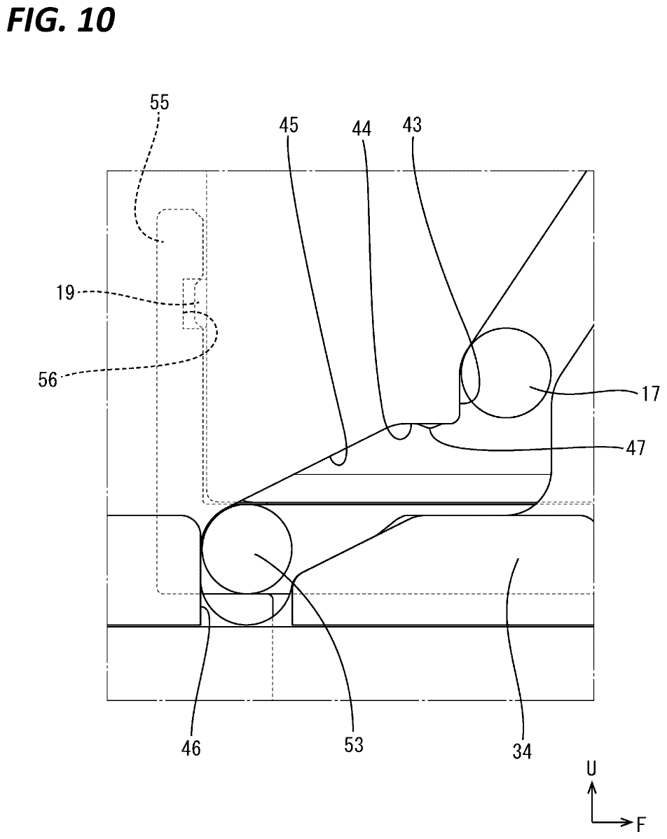

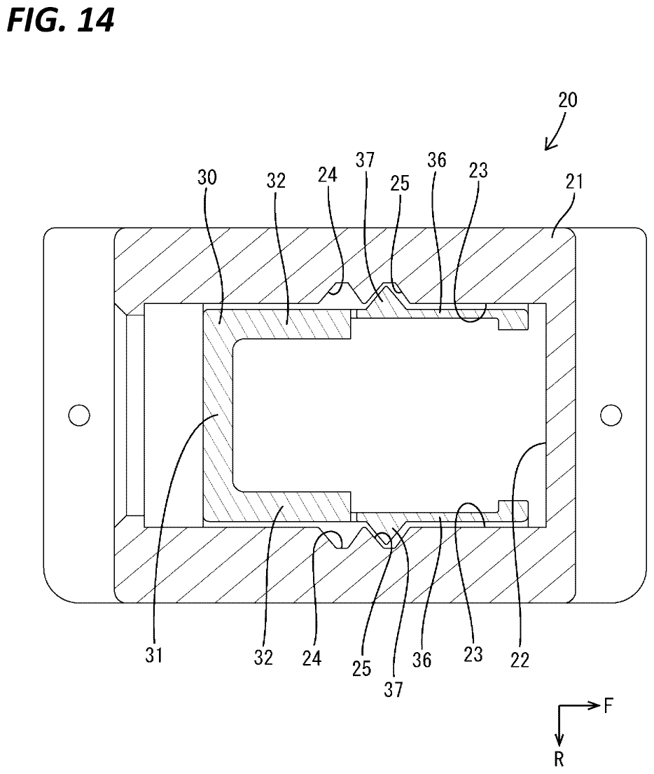

When the both housings 12, 50 reach a properly connected state, the first cam pins 17 reach the final end parts of the first guide grooves 42 (start end parts of the first release grooves 43) and the second cam pins 53 reach the final end parts of the second guide grooves 45 (start end parts of the second release grooves 46) as shown in FIGS. 9 and 10. When the both housings 12, 50 reach the properly connected state, the movable member 30 reaches a connection completion position. As shown in FIG. 14, the movable member 30 is held at the connection completion position by the locking of the locking projections 37 of the resilient locking pieces 36 and the connection completion position recesses 25.

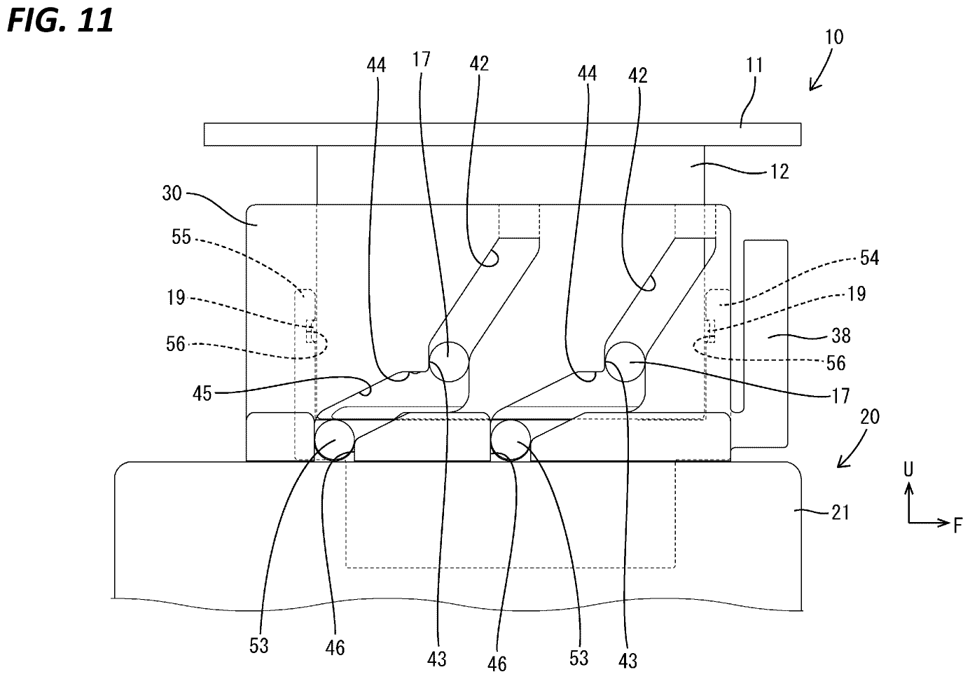

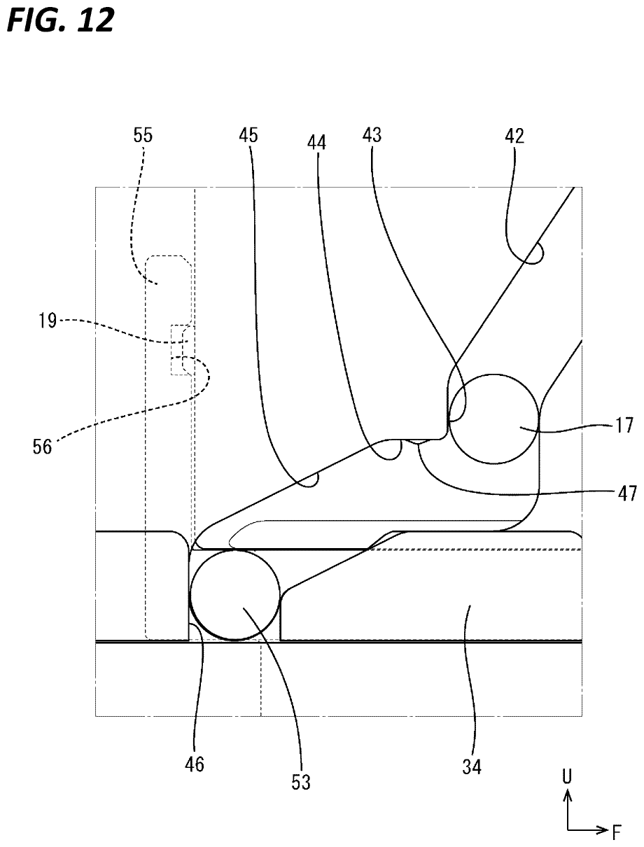

With the both housings 12, 50 properly connected, the first base member 11 has not reached a proper assembly position with the second base member 21. Thus, the first connector 10 is further lowered. During this time, the first cam pins 17 move downward in the first release grooves 43 and the second cam pins 53 move downward in the second release grooves 46, whereby a positional deviation in the vertical direction (direction parallel to the connection direction of the both housings 12, 50) between the first and second base members 11, 21 is absorbed. When the first base member 11 reaches a proper assembly position with the second base member 21, a lowering operation of the first connector 10 is completed (see FIGS. 11 and 12).

Unlike this embodiment, if an attempt is made to absorb the positional deviation in the vertical direction (direction parallel to the connection direction) between the first and second base members 11, 21 during the connection of the first and second housings 12, 50, a connection depth (positional relationship of the both housings 12, 50 in the connection direction) of the both housings 12, 50 varies when the connection of the both housings 12, 50 is completed. In contrast, in the connector device of this embodiment, a positional deviation between the first and second base members 11, 21 is absorbed by integrally moving the both housings 12, 50 in the properly connected state after the connection of the both housings 12, 50 is completed. Therefore, the connection depth of the both housings 12, 50 is stabilized.

With the both housings 12, 50 properly connected, the both front and rear coupling projections 19 of the first housing 12 and the both front and rear coupling grooves 56 are fit. In separating the both housings 12, 50 in the properly connected state, the first connector 10 is moved upward. In the initial stage of the movement, the second housing 50 moves upward integrally with the first housing 12 due to the locking of the coupling projections 19 and the coupling grooves 56. During this time, the first cam pins 17 move in the first release grooves 43 and the second cam pins 53 move in the second release grooves 46.

After the first cam pins 17 reach the final end parts of the first guide grooves 42 and the second cam pins 53 reach the final end parts of the second guide grooves 45, the first connector 10 is further moved upward. In the process of moving the first connector 10 upward, the first cam pins 17 move upward faster than the second cam pins 53 due to an inclination angle difference between the first and second guide grooves 42, 45. Thus, the locking of the coupling projections 19 and the coupling grooves 56 is released. If the locking of the coupling projections 19 and the coupling grooves 56 is released, the coupling of the first and second housings 12, 50 is released, wherefore only the first housing 12 moves upward and the both housings 12, 50 are separated.

The connector device of this embodiment includes the first and second connectors 10, 20. The first connector 10 includes the first base member 11 and the first housing 12 fixed to the first base member 11. The second connector 20 includes the second base member 21 provided to be able to relatively approach the first base member 11, the second housing 50 and the movable member 30. The second housing 50 is relatively displaceable with respect to the second base member 21 and can be connected to the first housing 12 as the first and second base members 11, 21 approach each other. The movable member 30 is mounted in the second base member 21 and can move between the connection start position and the connection completion position. The moving direction of the movable member 30 is a direction orthogonal to the connection direction of the first and second housings 12, 50.

The movable member 30 is formed with a guide portion (first and second guide grooves 42, 45) extending in the direction oblique to the connection direction of the both housings 12, 50. In the process of bringing the first and second base members 11, 21 closer, the first and second guide grooves 42, 45 guide to connect the first and second housings 12, 50 to each other while moving the movable member 30 from the connection start position to the connection completion position. In a state where the movable member 30 reaches the connection completion position, the connection of the first and second housings 12, 50 is completed and the both housings 12, 50 in a connection completed state can be integrally relatively displaced in the direction parallel to the connection direction with respect to the second base member 21.

According to the connector device of this embodiment, the first and second housings 12, 50 are connected by the first and second guide grooves 42, 45 in the process of bringing the first and second base members 11, 21 closer and, during this time, the movable member 30 moves from the connection start position to the connection completion position. In the state where the movable member 30 reaches the connection completion position, the both housings 12, 50 can be relatively displaced in the vertical direction parallel to the connection direction with respect to the second base member 21 while keeping the connection completed state. As the both housings 12, 50 are relatively displaced with respect to the second base member 21, the first and second base members 11, 21 are relatively displaced in the direction parallel to the connection direction of the both housings 12, 50. In this way, a positional deviation between the first and second base members 11, 21 can be absorbed in the direction parallel to the connection direction of the both housings 12, 50.

The movable member 30 has a guide function for connecting the first and second housings 12, 50, a first positional deviation absorbing function and a second positional deviation absorbing function. The first positional deviation absorbing function is a function for relatively displacing the second housing 50 in a state not connected to the first housing 12 in the two-dimensional directions (front-rear direction and lateral direction) with respect to the second base member 21. The second positional deviation absorbing function is a function for allowing the both housings 12, 50 in the connected state to be relatively displaced in the vertical direction with respect to the second base member 21.

The movable member 30 includes the guide portion for connecting the first and second housings 12, 50. The guide portion includes the first guide grooves 42, with which the first cam pins 17 of the first housing 12 are brought in sliding contact, in the process of connecting the both housings 12, 50. The movable member 30 is formed with the first release grooves 43 communicating with the final end parts of the first guide grooves 42. When the movable member 30 reaches the connection completion position, the first cam pins 17 enter the first release grooves 43, thereby being able to relatively move in the direction parallel to the connection direction with respect to the movable member 30. According to this configuration, when the connection of the both housings 12, 50 is completed in the process of bringing the first and second base members 11, 21 closer, the both housings 12, 50 are successively relatively displaced in the connection direction with respect to the second base member 21. In this way, the connection of the first and second housings 12, 50 and the positional deviation absorption of the first and second base members 11, 21 in the connection direction can be performed in one action.

The guide portion of the movable member 30 includes the second guide grooves 45, with which the second cam pins 53 of the second housing 50 are brought in sliding contact, in the process of connecting the both housings 12, 50. The movable member 30 is formed with the second release grooves 46 communicating with the final end parts of the second guide grooves 45. When the movable member 30 reaches the connection completion position, the second cam pins 53 enter the second release grooves 46, thereby being able to relatively move in the direction parallel to the connection direction with respect to the movable member 30. Since the guide portion extends in the direction oblique to the connection direction, the second guide grooves 45 included in the guide portion also extend in the direction oblique to the connection direction. As compared to the case where the second housing 50 is relatively displaced in the direction orthogonal to the connection direction with respect to the second base member 21 in the connection process without providing the second guide grooves 45, a stroke in the connection direction in the connection process of the both housings 12, 50 becomes longer. Since a sudden increase of connection resistance between the both housings 12 and 50 can be avoided in this way, workability is good.

The pair of first guide grooves 42 are provided apart from each other in the direction orthogonal to the connection direction (direction parallel to the moving direction of the movable member 30). The first cam pins 17 are arranged at the same interval as the pair of first guide grooves 42 in the front-rear direction orthogonal to the connection direction. According to this configuration, the inclination of the first housing 12 with respect to the movable member 30 can be prevented by bringing the pair of first cam pins 17 into sliding contact with the pair of first guide grooves 42.

The pair of second guide grooves 45 are provided apart from each other in the direction orthogonal to the connection direction (direction parallel to the moving direction of the movable member 30). The second cam pins 53 are arranged at the same interval as the pair of second guide grooves 45 in the front-rear direction orthogonal to the connection direction. According to this configuration, the inclination of the second housing 50 with respect to the movable member 30 can be prevented by bringing the pair of second cam pins 53 in sliding contact with the pair of second guide grooves 45.

The final end parts of the first release grooves 43 and the start end parts of the second guide grooves 45 communicate via the cam grooves 44. According to this configuration, when the second cam pins 53 are mounted into the second guide grooves 45, the second cam pins 53 can be guided into the second guide grooves 45 by the first guide grooves 42, the first release grooves 43 and the cam grooves 44.

The movable member 30 is provided with a holding portion (resilient holding pieces 38 and holding projections 47) for holding the second cam pins 53 in the start end parts of the second guide grooves 45. According to this configuration, since the second housing 50 is positioned with respect to the movable member 30 by holding the second cam pins 53 in the start end parts of the second guide grooves 45, a connecting operation of the first and second housings 12, 50 can be smoothly started.

The holding portion for holding the second cam pins 53 in the start end parts of the second guide grooves 45 includes the resilient holding pieces 38. The resilient holding pieces 38 are formed on the movable member 30 and exhibit a holding function by being locked to the front plate portion 54 of the second housing 50. The first housing 12 is provided with the releasing portions 18 for releasing the locking by the resilient holding pieces 38 when the connection of the both housings 12, 50 is started. According to this configuration, when the connection of the both housings 12, 50 is started, the holding by the resilient holding pieces 38 is released by the releasing portions 18 and the second housing 50 becomes relatively movable with respect to the movable member 30. Since an operation for only releasing the holding of the resilient holding pieces 38 is not necessary, workability is good.

### Other Embodiments

The present invention is not limited to the above described and illustrated embodiment, but is represented by claims. The present invention includes all changes in the scope of claims and in the meaning and scope of equivalents and also includes the following embodiments.

Although the guide portion includes the first and second guide grooves in the above embodiment, the guide portion may be configured to include only the first guide grooves and the second housing may be relatively displaceable in the direction orthogonal to the connection direction with respect to the movable member.

Although the pair of first guide grooves are provided apart from each other in the direction orthogonal to the connection direction (direction parallel to the moving direction of the movable member) in the above embodiment, only one, three or more first guide grooves may be provided.

Although the pair of second guide grooves are provided apart from each other in the direction orthogonal to the connection direction (direction parallel to the moving direction of the movable member) in the above embodiment, only one, three or more second guide grooves may be provided.

Although the final end part of the first release groove and the start end part of the second guide groove communicate via the communication groove in the above embodiment, the final end part of the first release groove and the start end part of the second guide groove may not communicate.

Although the resilient holding pieces are formed on the movable member in the above embodiment, the resilient holding pieces may be formed on the second housing.

Although the second base member is fixed and the first base member is brought closer to the second base member in the above embodiment, the first base member may be fixed and the second base member may be brought closer to the first base member or both the first and second base members may be brought closer to each other.

### LIST OF REFERENCE NUMERALS

10 . . . first connector
11 . . . first base member
12 . . . first housing
13 . . . terminal holding portion
14 . . . receptacle
15 . . . first terminal fitting
16 . . . guide pin
16S . . . first tapered sf
17 . . . first cam pin
18 . . . releasing portion
19 . . . coupling projection
20 . . . second connector
21 . . . second base member
22 . . . working space
23 . . . guide rail
24 . . . connection start position recess
25 . . . connection completion position recess
30 . . . movable member
31 . . . rear wall portion
32 . . . side wall portion
33 . . . connection space
34 . . . rib
35 . . . groove portion
36 . . . resilient locking piece
37 . . . locking projection
38 . . . resilient holding piece (holding portion)
39 . . . projection
41 . . . entrance groove
42 . . . first guide groove (guide portion)
43 . . . first release groove
44 . . . communication groove
45 . . . second guide groove (guide portion)
46 . . . second release groove
47 . . . holding projection (holding portion)
50 . . . second housing
51 . . . housing body
52 . . . guide hole
52S . . . second tapered sf
53 . . . second cam pin
54 . . . front plate portion
55 . . . rear plate portion
56 . . . coupling groove
57 . . . holding recess
58 . . . guide recess
α . . . inclination angle of first guide groove
β . . . inclination of second guide groove

1. A connector device, comprising:
a first base member;
a first housing fixed to the first base member;
a second base member provided to be able to relatively approach the first base member;
a second housing relatively displaceable with respect to the second base member, the second housing being connectable to the first housing as the first and second base members approach each other; and
a movable member mounted in the second base member, the movable member being movable between a connection start position and a connection completion position in a direction orthogonal to a connection direction of the first and second housings,
the movable member being formed with a guide portion extending in a direction oblique to the connection direction,
the guide portion guiding to connect the first and second housings to each other while moving the movable member from the connection start position to the connection completion position in the process of bringing the first and second base members closer, and
connection of the first and second housings being completed and the first and second housings in a connection completed state being integrally relatively displaceable in a direction parallel to the connection direction with respect to the second base member in a state where the movable member reaches the connection completion position.

2. The connector device of claim 1, wherein:
the guide portion includes a first guide groove, a first cam pin of the first housing being brought into sliding contact with the first guide groove in the process of connecting the first and second housings,
the movable member is formed with a first release groove communicating with a final end part of the first guide groove, and
the first cam pin enters the first release groove and becomes relatively movable in the direction parallel to the connection direction with respect to the movable member when the movable member reaches the connection completion position.

3. The connector device of claim 2, wherein:
the guide portion includes a second guide groove, a second cam pin of the second housing being brought into sliding contact with the second guide groove in the process of connecting the first and second housings,
the movable member is formed with a second release groove communicating with a final end part of the second guide groove, and
the second cam pin enters the second release groove and becomes relatively movable in the direction parallel to the connection direction with respect to the movable member when the movable member reaches the connection completion position.

4. The connector device of claim 2, wherein:
a pair of the first guide grooves are provided apart from each other in the direction orthogonal to the connection direction, and
the first cam pins are arranged at the same interval as the pair of first guide grooves in the direction orthogonal to the connection direction.

5. The connector device of claim 3, wherein:
a pair of the second guide grooves are provided apart from each other in the direction orthogonal to the connection direction, and
the second cam pins are arranged at the same interval as the pair of second guide grooves in the direction orthogonal to the connection direction.

6. The connector device of claim 3, wherein the final end part of the first release groove communicates with a start end part of the second guide groove.

7. The connector device of claim 3, wherein the movable member is provided with a holding portion for holding the second cam pin in a start end part of the second guide groove.

8. The connector device of claim 7, wherein:
the holding portion includes a resilient holding piece formed on one of the second housing and the movable member and exhibiting a holding function by being locked to the other of the second housing and the movable member, and
the first housing is provided with a releasing portion for releasing locking by the resilient holding piece when the connection of the first and second housings is started.
